(19) United States
(12) Patent Application Publication
(10) Pub. No.: US 2012/0033249 A1
(43) Pub. Date: Feb. 9, 2012

(54) Trigger-activated Contextual User Session Recording

(76) Inventor: David Van, Jersey City, NJ (US)

(21) Appl. No.: 12/850,789

(22) Filed: Aug. 5, 2010

(51) Int. Cl. G06F 15/00; G09G 5/00

(52) U.S. Cl. 358/1.15; 345/642

(57) ABSTRACT

Embodiments of the disclosed technology include a method and device for obtaining screenshots of active windows of a video output based upon non-printable keyboard input and/or a change in active window. Upon such a still image being obtained, printable text characters entered between the time of a prior-taken still image (or since the method began to be carried out) and the time of the still image gleaning, are associated with the still image. The printable text is searchable, with results returning a still image. Such a method can be used to view the operation of a remote computer via still images of its video output, or the like.

### FIELD OF THE DISCLOSED TECHNOLOGY

The disclosed technology relates generally to security logging and, more specifically, to logging user activity.

### BACKGROUND OF THE DISCLOSED TECHNOLOGY

Security logging methods and devices include such products as video monitors for capturing video, key loggers for capturing keystrokes typed into a computer, and protocol-specific logging to read data passing through a router. However, especially with regard to computer usage or many computers on a network, such logging is expensive.

In order to conduct video capture on a computer, a large amount of storage space is needed. For a 1280×720 resolution screen (known as HDTV 720 p), depending on compression, over 3 gigabytes of data need to be stored per minute, which, in addition to taking up an unwieldy amount of space, provides a tremendous strain on a computer being logged. Even at low frame rates and lower resolutions, on a typical computer, the strain on performance often makes a computer nearly unusable. Still further, to sift through very many hours of video log data is time consuming, yields few positive results when searching for a specific activity, and is prone to error as the few important seconds of data may be passed over.

Another method in the prior art for logging is protocol-specific recording. That is, for example, all remote access to another computer is logged, such as all FTP (file transfer protocol), SSH (secure shell), or all remote desktop traffic (typically, over port 3389) is logged. The problem with this approach is that a user can subvert the logging simply by using a different protocol or by changing the port in use. Dependency on any specific port or specific protocol for logging is therefore insufficient.

Recording using keyboard logger (both software and hardware are available) captures a list of what the user typed, but each input has no context to the user's session. For example, if the logger captured the word “shutdown,” it is often unknown in terms of where the user typed this. Perhaps it was in the context of turning off a remote computer, a command in a text adventure, or in a therapist's note about the mental state of a client. Context is the key to knowing what the user meant.

Another option is to use screen captures at various moments in time; however, such screen captures are non-searchable. While less data is required compared to a video log, the image or images are still just a series of pixels without any context as to meaning, and search ability is quite limited.

U.S. Pat. No. 6,968,509 to Chang and Wen attempts to solve some of these problems by detecting a change in focus (such as selecting a new window), and using keyboard logging and mouse selection logging upon such a change in focus. In this sense, the logged data has some context associated with it. While this may be sufficient to reproduce a malfunction, as is the purpose of the logging in the '509 patent, a more rigid and thorough logging is needed in the case of logging for security purposes.

### SUMMARY OF THE DISCLOSED TECHNOLOGY

It is therefore an object of the disclosed technology to provide a searchable screenshot log of computer usage.

It is a further object of the disclosed technology to log mouse and keyboard input in connection with data exhibited on a screen at the time.

It is a further object of the disclosed technology to allow searching of inputted data corresponding to data exhibited on a display.

In an embodiment of the disclosed technology, a method of storing searchable still images of a pre-designated portion of a video output is claimed. The method proceeds by way of designating a portion of the video output as an active window (such as, as defined by an operating system, a window selected which is in front of others, a window in which keyboard input affects, or has a different colored title bar than, others). A still image version of the active window is stored upon non-printable user input or upon designation of a new portion of the video output becoming the active window. That is, upon a mouse click or non-printable key such as the “Control” or “Alternate” key being depressed, a screenshot or still image version of the video is taken. All printable input received from a user between the step of designating and the step of storing is associated with the screenshot or still image, as is explained in further detail in the detailed description. The still image version is then displayed with at least a portion of the printable input.

The displaying of the still image version, in the method described above, may be based on a query of at least the portion of the printable input which is displayed. Many images may be stored, and each image may be associated with printable input corresponding to a still image of the many (or plurality of) still images.

The still images may be exhibited in sequence, based on the time in which they were actually viewed or generated. The exhibiting in sequence, for example, may be used to view the images in real-time, which, for purposes of this disclosure, is defined as soon as practicable, given network lag and computer processing time. That is, a user viewing the screenshots in real time over a network views the screenshots after they have been created and had a chance to propagate over a network to a local video screen. The remote real-time video may be triggered based on a pre-defined printable input, such as, when a person types “hack,” a remote video screen may jump, or draw attention, to this computer, for surveillance. Similarly, such a computer associated with the trigger may receive limited, less, restricted, or no network connectivity to a part of the network (local area network, wide area network, or general internet network) upon a pre-designated string being inputted.

The plurality of images may be generated from multiple computers or video outputs, that is, from a first video screen and a second video screen. A title of an active window may be associated with the still image version of a screenshot of a video. A search query may include a search for at least a part of the title and return a result which includes the still image version associated thereto.

A further step of the method of the disclosed technology, in embodiments thereof, is optical character recognition to generate text from the still image version. The generated text may be further searchable by way of the search query. The generated text, or a part thereof, may also be designated as being part of an actionable object, such as a button which may be pressed (or was pressed) or a portion of the video output which is selectable to cause a further action to take place, e.g., cause a computer to shut down.

In another embodiment of the disclosed technology, a server—a device (or devices) which receives, sends, and stores electronic data—has a data storage device configured to store still image versions of an active window of a video output. The still images are associated with printable text characters inputted by a viewer interacting, by way of a hardware input device (such as a mouse or keyboard) with the active window of the video output. An input interface, such as by way of a network adapter, is adapted to receive a text-based search query. An output interface, such as by way of the network adapter, is adapted to send, in response to the text-based search query, results which have at least a portion of printable text characters inputted, using the hardware input device of the viewer and at least one still image associated with at least a portion of the printable text characters inputted by the viewer.

In an embodiment of the above, the still image versions of the active window are stored upon non-printable input of the viewer or upon designation of a new portion of the video output as the active window. The server may send, via the output interface, each of the still image versions in a sequence, sorted by time. This sequence of sent images may be sent in real-time (as defined above).

Image versions may be from multiple sources, such as a first and second video screen, and other features applicable to the method of the disclosed technology are further applicable to the server device and other devices used to carry out embodiments of the disclosed technology.

Further details are set forth in the detailed description below.

### BRIEF DESCRIPTION OF THE DRAWINGS

FIG. 1 shows a high level flow chart of embodiments of the method of the disclosed technology.

FIG. 2 shows methodology used in conducting a search query in embodiments of the disclosed technology.

FIG. 3 shows an example of an image of a screenshot of an active window and actionable text which may be searchable in embodiments of the disclosed technology.

FIG. 4 shows the data gleaned from the image of FIG. 3 in table format.

FIG. 5 shows an example of a video output and data stored in connection with still image versions of an active window of the video output.

FIG. 6 shows an example of a still image version of an active window of a video display and a recent log of stored still images.

FIG. 7 shows a high-level block diagram of a device that can be used to carry out embodiments of the disclosed technology.

FIG. 8 shows a high-level block diagram of a device that may be used to carry out embodiments of the disclosed technology.

### DETAILED DESCRIPTION OF EMBODIMENTS OF THE DISCLOSED TECHNOLOGY

Embodiments of the disclosed technology include a method and device for obtaining screenshots of active windows of a video output based upon non-printable keyboard input and/or a change in active window. Upon such a still image being obtained, printable text characters entered between the time of a prior-taken still image (or since the method began to be carried out) and the time of the still image gleaning, are associated with the still image. The printable text is searchable, with results returning a still image. Such a method can be used to view the operation of a remote computer via still images of its video output, or the like.

Embodiments of the disclosed technology will become clearer in light of the following description of the figures. In steps 110 and 115, a keyboard and mouse are actively polled for input. Any input devices known in the art for interacting with a computer may be used (e.g., joystick, touch screen, and so forth). The input layer is controlled by the operating system, and thus, any input which interacts with the operating system is usable in embodiments of the disclosed technology. Keyboard input, as is known in the art, comprises alphanumeric characters (A-Z, 0-9), and other printable characters (such as ! through + above the three rows of letters on a standard U.S. keyboard). Such characters are part of regular printable input. Other regular printable input, depending on the language of the user, includes, in embodiments of the disclosed technology, standard characters in other languages. On the contrary, a control character, such as (the “Control” key, “Enter” key, “Alt” key, “Insert” key, etc.) is generally a non-printable character. While some specifications may, for example, assign a printable heart to the Ctrl-C combination, etc., for purposes of this disclosure any use of a control character is defined as a non-printable input. Thus, printable input from a keyboard is defined as a key or combination of keys which, when pressed, regularly functions to cause a specific character used in regular written communication between people to appear on the video output. Non-printable input is defined as a key press or combination of key presses for the purpose of, or which result in, something other than to the contribution, or the display, of a character on a video output. Non-printable input, in embodiments of the disclosed technology, is for purposes of interacting with a computer device to change a setting or instruct the device to carry out a new function or procedure. Mouse input is also non-printable input; however, in step 115, movement of the mouse is ignored in embodiments of the disclosed technology, and only a mouse-click (depression of a mouse button) is defined as non-printable input. In other embodiments, movement greater than a threshold amount is treated as non-printable input.

Thus, in step 120, it is determined whether non-printable input has been entered. This takes place, for example, after each input or interrupt from a mouse, keyboard, or other input device. The operating system of a computer may handle this determination. If no input is received, or all input received is not in the non-printable category (as defined in the prior paragraph), then it is determined whether, in step 125, the focus has shifted to a new window. New window focus is determined based on an operating system signal or determination of such, indicating that a new window is now the “foreground,” “primary,” or “active” window. That is, a printable keystroke entered will act on a new application or area of the video output. New window focus may come in the form of changing a color or brightness of a window, such as changing the color or brightness of a title bar. If, in step 125, it has been determined that the present window is still the active window, then no screenshot is taken and the method reverts back/continues to poll for keyboard or mouse input.

Once either a non-printable input (step 120) or new window focus (step 125) is detected, a still image of the active window is stored in step 130. This refers to the window which is active before a change based on the non-printable input and/or new window focus in steps 120 and 125. As an example, assuming window A is the active window: A user enters non-printable input of the “Alt” key combined with the “Tab” key which, in certain operating systems, allows one to select a window to become the active window. The user selects window B as the active window. In this example, non-printable input has been entered (the “alt” key), and a new window (window B) becomes the active window. Just before window B becomes the active window, a screenshot of window A is taken and stored. (In other embodiments, a screenshot of window B might also be taken.)

In step 140, in connection with the still image which is stored in step 130, prior printable input is stored. While this will become clearer in view of the foregoing figures, the manner in which this is carried out is as follows. A first still image might be stored when a user opens a word processor. The user then begins to type out a paragraph. At the end of the paragraph, the person hits the “enter” key (a non-printable, control character for purposes of this disclosure). At this time, in step 120, the non-printable input question is answered “yes” and steps 130 and 140 are carried out. In this case, in step 140, in connection with the still image of the active window (in this case, the word processor), the text of the paragraph entered from the time of opening the word processor until (and may include) the enter key is retrieved and then, in step 145, associated with the still image of the active window. In other words, the text is logged (known in the art as “key logging”) and associated in a database with a screenshot or still image version of the active window taken just after entering the text/keys. Now, assuming the user types some more text and then clicks on the “File” menu or hits “Ctrl” and “s” to save the document, a screenshot/still image is taken, and the text typed between the last screenshot/still image is associated with the active window. More examples, showing actual screenshots are disclosed below.

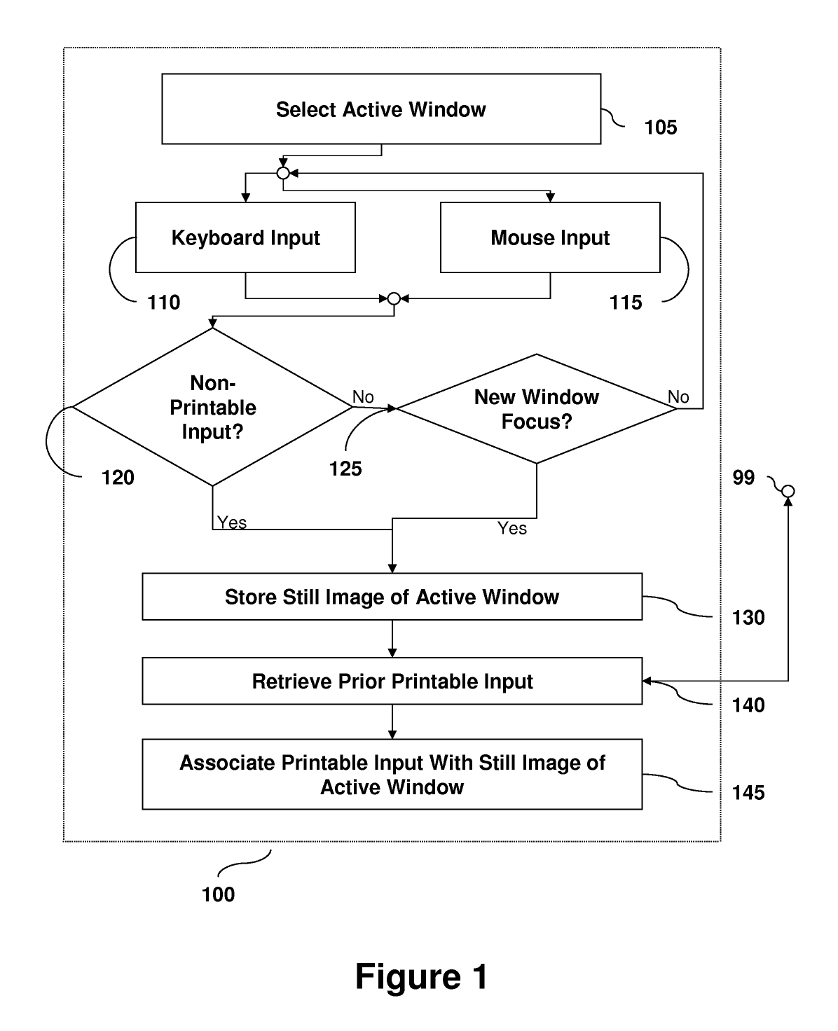

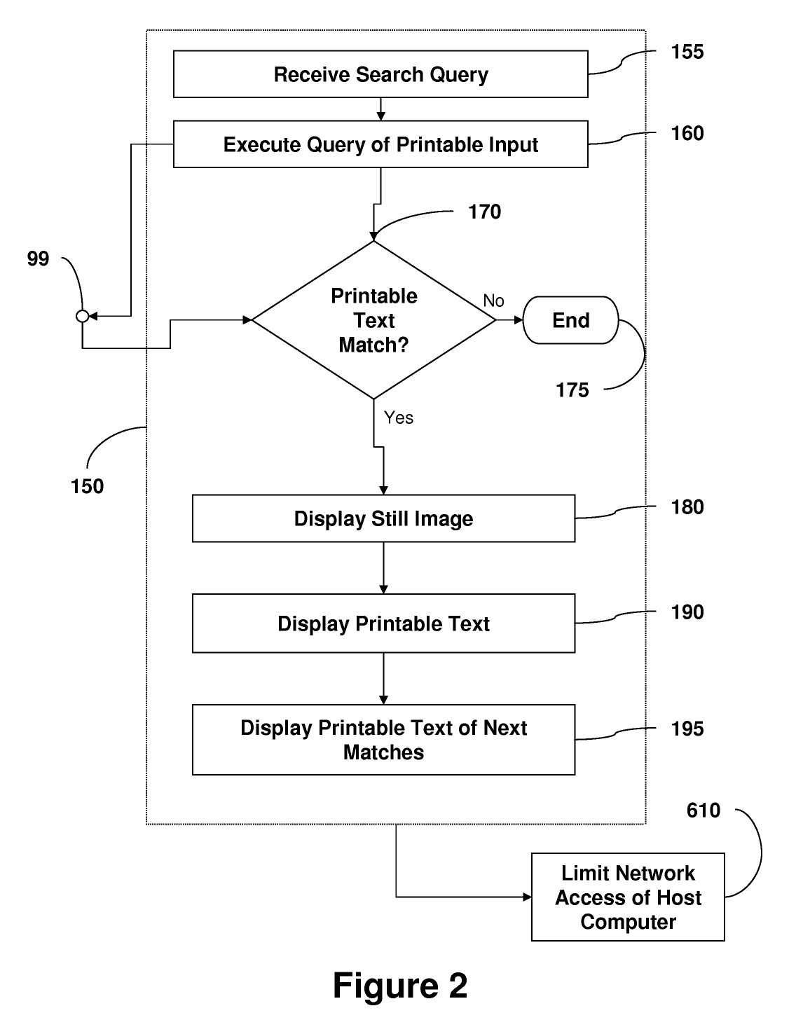

FIG. 2 shows search methodology used in conducting a search query in embodiments of the disclosed technology. Connect point 99, shown in both FIGS. 1 and 2, is used to illustrate the connection between steps conducted with respect to still image storing 100 and the search methodology 150. When conducting a search 150, the search interacts with the stored text and still images to return relevant results. In step 155, a search query is received. Such a search query, in embodiments of the disclosed technology, is a text-based search query. In step 160, a query of the text is made on the received printable input of step 140. If there is no match of the text of the query with the prior printable input, as determined in step 170, then step 175 is carried out, and the search query ends. That is, the user is notified of, or receives no, positive matches. If there are results which correspond to the query received in step 155, then steps 180-195 are carried out (in any order and in embodiments, in connection with a list of search results in the form of still images and/or text). In step 180, a still image is displayed. Such a still image corresponds to the still image of an active window stored in step 130, as well as to the printable input retrieved in step 140 and in the search query received in step 155. Likewise, the corresponding printable text in step 190 may be displayed, the text corresponding to the prior printable input 140 and search query 155. In step 195, optionally, printable text of other matches may be displayed, and a user may select one of these matches to display the corresponding still image. In this manner, contextual data in the form a screenshot may be displayed with respect to search queries for keyboard input.

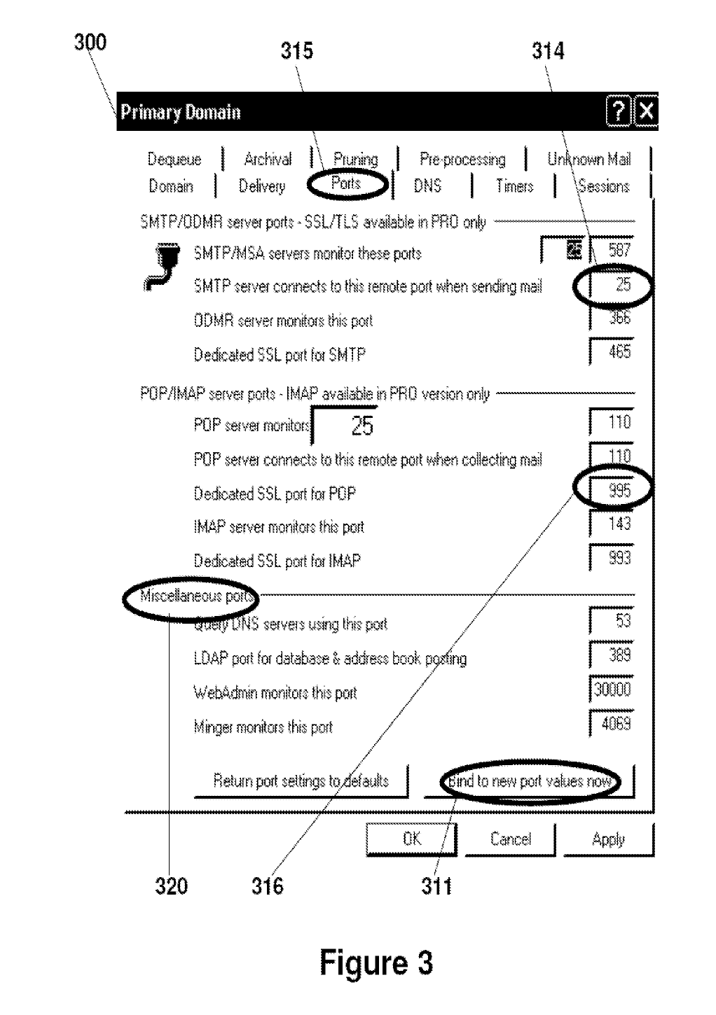

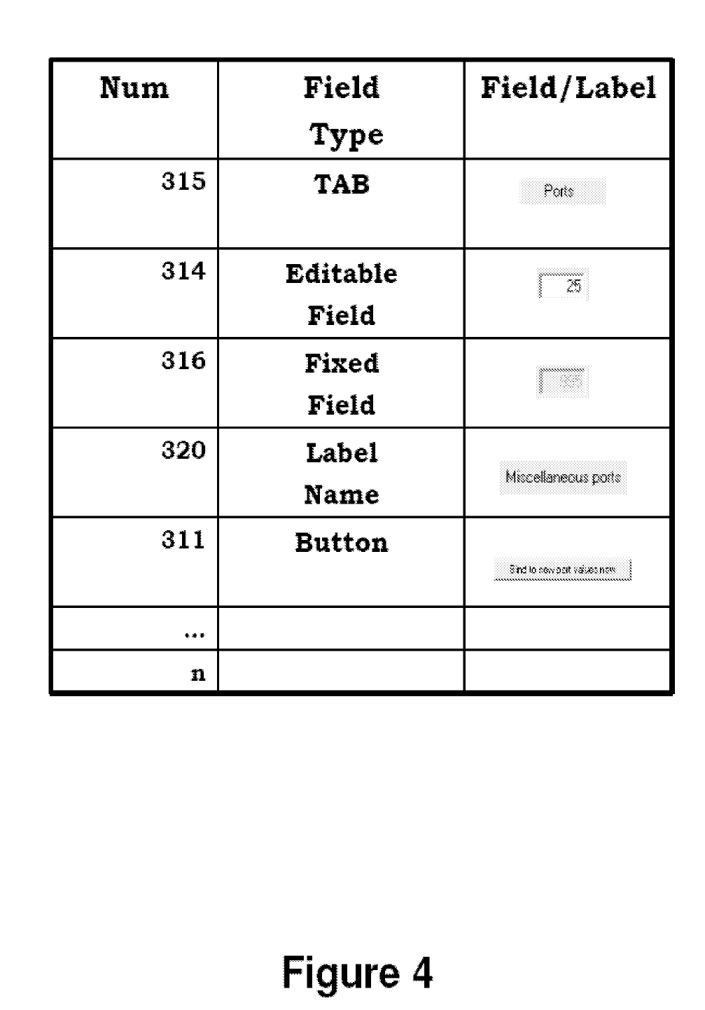

Other data which may be stored to aid in contextual search include window titles and items selected. That is, when storing a still image of an active window in step 130, the title of the active window may also be stored and a search query may be executed on such text, just as it is executed on printable input. Likewise, buttons selected with a mouse (or keyboard) often comprise text. Such text may be associated with a still image version of a display of the video output. When selected, the text of the button is associated with the still image version, such as an image stored just before carrying out of the function or anticipated result of using the button. Embodiments of the disclosed technology accomplish retrieving actionable items from still image versions of an active window by way of embodiments disclosed with respect to U.S. patent application Ser. No. 12/641,363, filed on Dec. 18, 2009. The '363 reference is hereby expressly incorporated by reference. FIGS. 3 and 4 describe some of the features of the '363 reference, and how such features can be used in conjunction with embodiments of the disclosed technology. Actionable items are those items which can be selected or edited and cause a change in functionality or window displayed on a computing device.

FIG. 3 shows an example of an image of a screenshot of an active window and actionable text which may be searchable in embodiments of the disclosed technology. The image 300 comprises a tab 315 named “Ports” which is currently selected, and various fields and data associated with ports are shown below. As the interface shown uses a typical GUI (graphical user interface), detection based on color, location, and OCR (optical character recognition) may be utilized to aid in determining editable fields and the like. In addition, other tabs may be detected and selected to show further editable elements. Fixed elements, such as fixed element 316, in this case, the dedicated SSL port for POP (an encrypted connection to a point of presence mail server) comprises a value of “995” which may be read and converted into searchable text for monitoring current configuration settings in a common interface for a plurality of specialized hardware devices. A label 320, in this case, serves a header for a group of editable fields. A button 311 allows changes to take effect immediately. In a common interface, the values shown may be edited and the button selected to allow the changes to take hold. Each of these elements, labels, and buttons is an actionable object.

FIG. 4 shows the data gleaned from the image of FIG. 3 in table format. The image 300 comprises elements 311, 314-316, and 320. For each element, a field type can be developed for a tabular output as shown in the “Field type” column, corresponding to a specific field or label, shown in the third column. Thus, for example, the tab 315 refers to a specific portion of the image as shown in the first row, third column. Using OCR software, such as, for example, the Google Tesseract Engine, as is known in the art, the field/label portions of the image 300 are converted, in embodiments of the disclosed technology, into text. The text can then be placed into text format and used as part of search queries. Such searches may be of plain text or specifically for a field containing or comprising a specific value. That is, one may search screenshots of active windows for all occurrences that have an editable field with the value of “25” in it, and/or limit such a search to “25” in the context of choosing port 25. In this manner, searches will exclude where a user has typed “25” into a word processor. The context provides the key, and the context is searchable to ensure relevant results.

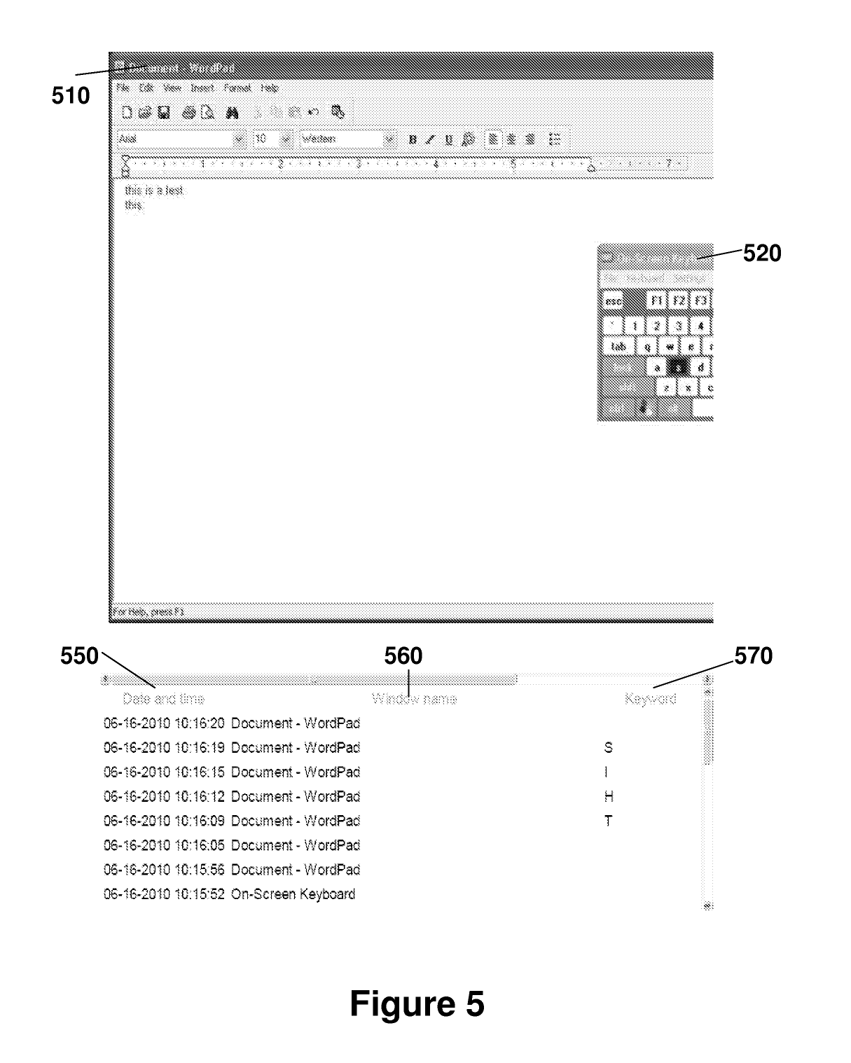

FIG. 5 shows an example of a video output and data stored in connection with still image versions of an active window of the video output. The video output, in this example, comprises a display of an active window 510 and an inactive window 520. As described above, still image versions of the active window are stored just before the active window loses focus, or upon certain non-printable input being received (as defined above). Here, the words “this is a test” were entered and then the active window was changed to the “On-Screen Keyboard,” which is the inactive window 520. Thus, a still image of the window 510, which comprises the rectangular application “WordPad,” was stored with the words, “this is a test” written therein. When the On-Screen Keyboard became the active window (window 520), the user proceeded to type by way of mouse clicks. Each mouse click, a defined non-printable character, triggered a still image version being stored. At the bottom half of the figure, the stored entries may be seen, along with the date and time 550, window name 560, and words typed 570. The entries from 10:16:09 to 10:16:19 in the date and time field 550 each show a respective letter entered based on a mouse click of a letter. Also, it should be noted that the “s” in windows 520 has inverted colors, as it is currently depressed while this screenshot was taken. Thus, this is an example of image context to text being typed.

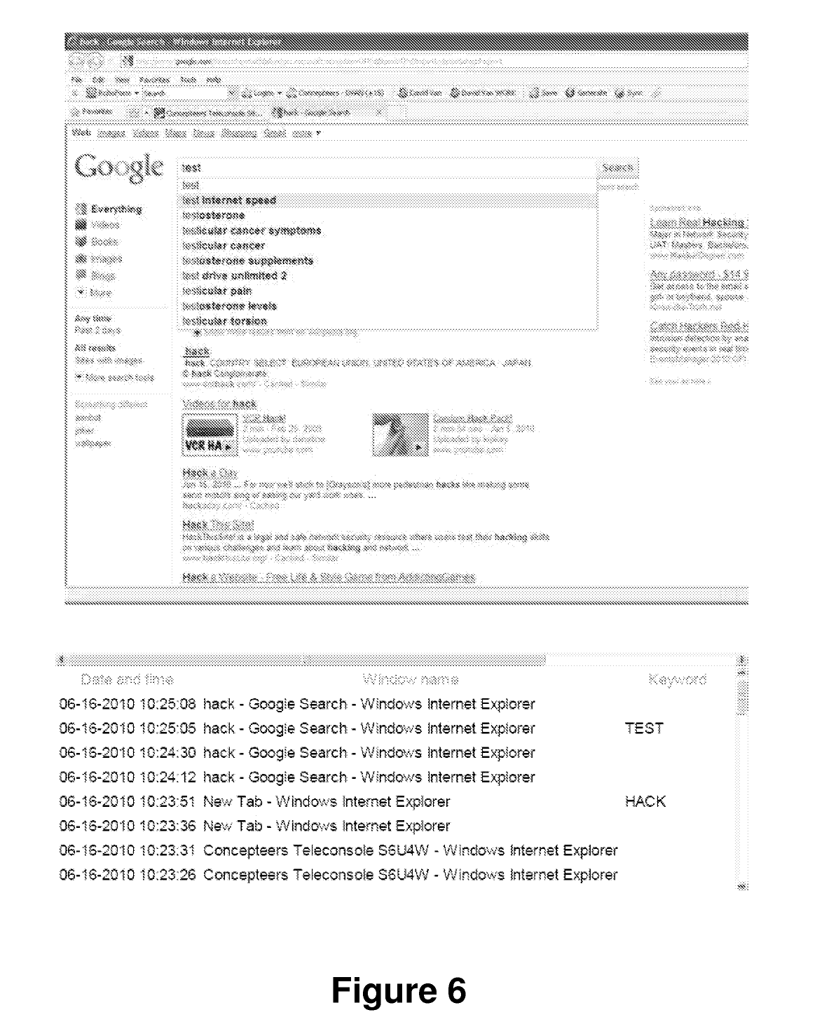

FIG. 6 shows an example of a still image version of an active window of a video display and a recent log of stored still images. The screenshot is shown is of an active window taken just before carrying out an action resulting from use of a non-printable or control character. That is, the user has typed in “test” into a search bar of an internet search engine and has, for example, hit the “enter” key (a non-printable control input). A still image of the active window is stored along with the word “test,” and then the function of hitting the “enter” key is carried out, whereby the search for this word is sent to the search engine. In this case, referring to the second entry shown in the lower portion of this screen at 10:26:05, it can be seen that the user was on a page entitled, “hack—Google Search” in the program “Windows Internet Explorer,” and the person typed in the word “TEST.” These data are associated with the still image, and thus, the still image becomes searchable or displayable based on a search or display of the associated text.

Referring still to FIG. 6 (and the figures in general), in embodiments of the disclosed technology, user activity may be watched in real-time. Real-time is defined, for purposes of this disclosure, as soon as practicable, given network conditions and computer processing ability. Thus, as the still image shown in FIG. 6 is taken, it is stored and transferred over a network to a remote location, where it is viewed by another (a person other than the person primarily or solely responsible for manipulating the video output and resulting still images generated). In this manner, a user's activity on a computer can be monitored remotely (at another computer) and stored while using a minimal amount of space. Previously, as disclosed in the Background section of this disclosure, it would be necessary to monitor a video feed which is taxing on the resources of a computer, requires a large amount of bandwidth and storage space, and is not easily searchable. By providing still image versions of key moments in the use of a computer, and only relevant portions of a screen, the data size and the resources (e.g., processing time) used on a computer are greatly reduced.

Referring again to FIG. 2, a real-time search query will now be discussed. Such a search query continues to run while a user or users are interacting with a computer. In step 155, a search query is received, such as for the word “hack” (see FIG. 6). In a corporate or government setting, many computers may be monitored at once, such as all computers within a military installation, a government agency, or on an intranet of a corporation. Thus, it may be desired to ensure that government or corporate secrets are not being leaked, or to detect and trace users who may be problematic. In step 160, a search query is executed on printable input, and, in this case, the search continues to run on a new printable input which is created as step 110 of FIG. 1 (keyboard input) is carried out. Such printable input is stored on a memory storage device (such as and including volatile memory or non-volatile memory). When a match is found in step 170, then a computing device used to monitor a plurality of computers will be alerted. The printable text entered (step 190), and/or associated still images (180), may be displayed on the remote computer. Or, a notification may be sent to the remote computer. In step 610, network access of the host computer, that is, the computer from which the still image was generated from its video output, is limited. This may be by way of disabling network access of the host computing device entirely, limited network access to a portion of the network (such as the intranet), or allowing access only to a specific subset of other computing devices, websites, and/or protocols. The limiting of network access in step 610 may take place immediately upon a printable text match (step 170) being found, or at the command of a remote user.

Still further, in embodiments of the disclosed technology where network access of a host computer is limited or a still image is displayed based on a specific printable text match, the actions carried out (displaying the image or limiting network access) may be limited to a particular context. For example, referring again to FIG. 3, note that the SMTP port 314 is currently set at port 25. As is known in the art, this is the standard port for a mail server and such a server is often behind a firewall and is monitored. A user may attempt to change this to port 2525, a secondary port used by some internet service providers to get around a firewall on port 25. A government institution, corporation, or the like, could simply choose to firewall port 2525. However, this becomes a rat race, as then a user could get around this firewall by using yet another port, and so on and so forth. Instead, network access may be cut off, or a supervisor or person monitoring internet connections may be notified upon a user viewing a screen titled, “Primary Domain” or selecting a tab 315 entitled “Ports.” Such triggers may further be limited if the user clicks into a box with the “25” number in it, indicating that they may be about to change the mail server port. Upon performing one of these pre-defined actions reduced to printable text, a match is determined in step 170 of FIG. 2, and then the still image or text is displayed to the person monitoring security in steps 180 and/or 190, such as in real-time, or based on a search query. The still image provides a context, allowing for human verification that security is being breached and/or evidence which may be used to incriminate the offender.

In cases where, for example, a security breach has already occurred, one can search the still image logs (based on the associated text) to uncover where the security breach occurred. For example, if it is known that a document was leaked from a certain government agency to the media, the name of this document or keywords which might be associated with, or used by, an employee who leaked the document may be searched. Now, instead of going through hours and hours of video images of computer screens, even if it were practicable to obtain such videos, text queries allow for sifting through still images of key moments in time in computer use, perhaps across hundreds or thousands of computers.

Still further, referring again to FIG. 6, images may be played in sequence, in real-time (as they are being produced) or simply in the order in which the images were shown on a video output in the past. When viewing past images, the images may be displayed spaced apart in time as they were displayed on the original video output. A viewer may choose to select one video after the other to watch the progression of use of a computer/video output faster than was displayed initially.

In yet another embodiment of the disclosed technology, the still image is displayed, with or without the separate printable text, may be displayed in connection with an audio conference between a host computer (comprising the video output) and a remote viewer and conference participant. Thus, instead of a video stream of a person's computer screen, which is often fraught with delays and low quality, a series of images of an active window or entire video window are sent, based on the triggers of entering of a non-printable character or change in active window.

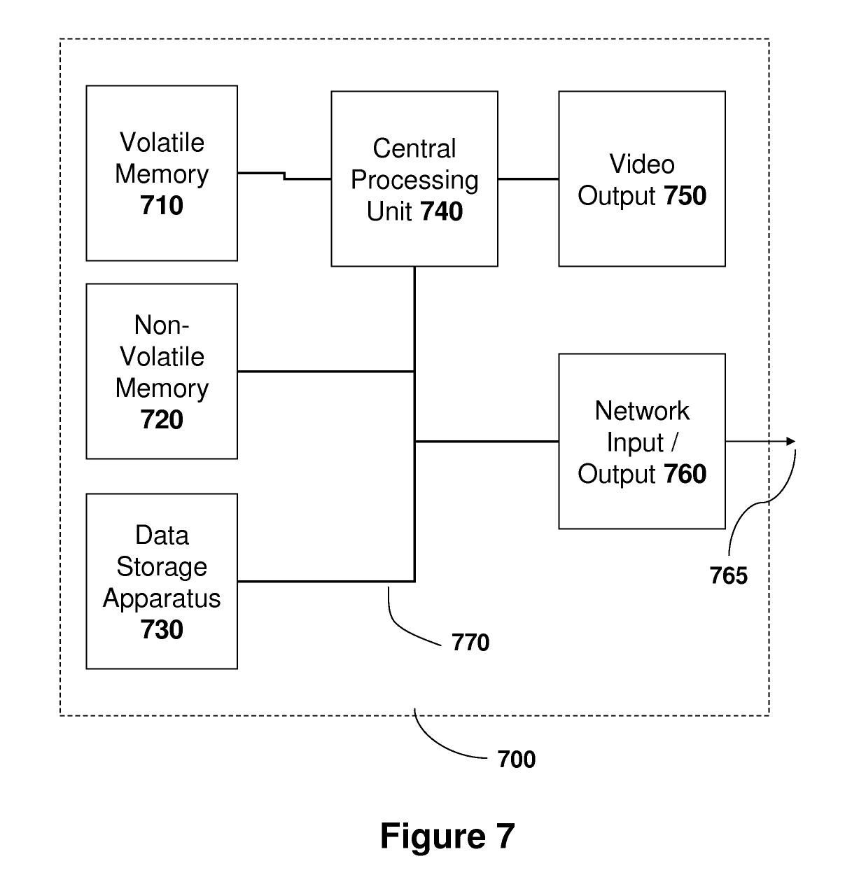

FIG. 7 shows a high-level block diagram of a device that may be used to carry out embodiments of the disclosed technology. Data storage apparatus 730 refers to a long-term data storage device, such as magnetic or optical media which retain data. The data storage apparatus is used in embodiments of the disclosed technology to store still image versions of video output or active windows thereof. As shown in FIG. 7, it resides on the same computer device as the video output 750. It is the video output 750, or a portion thereof, which is captured in the form of a still image (or screenshot) and stored on the data storage apparatus 730, or a data storage apparatus located on another computing device, or which serves as a fileserver. Other types of storage apparatuses used in embodiments of the disclosed technology include volatile memory 710 and/or non-volatile memory 720. A central processing unit 740 controls operation of such devices, and the devices are connected by a data bus 770 which transfers data to and from various devices within the overall computing device 700. A network input/output 760, such as a network card or interface, sends and receives data between the computational device 700 and other devices, such as switches, hubs, routers, and servers, via data connection 765. Likewise, a server computer may operate using the devices shown herein, in FIG. 7. Such a server computer receives still image versions of video output of one, two, or many other video outputs, the still images associated with, at least in part, printable text. The server may also be the device on which a search query is carried out, and search results are returned.

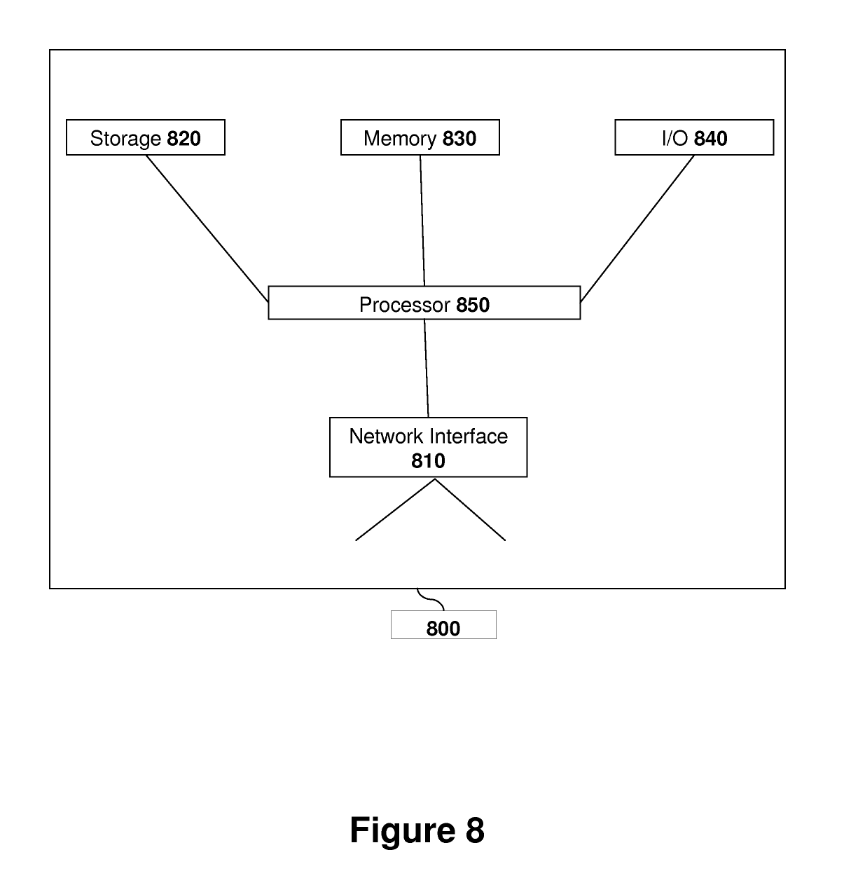

FIG. 8 shows a high-level block diagram of a device that may be used to carry out embodiments of the disclosed technology. Device 800 comprises a processor 850 that controls the overall operation of the computer by executing the device's program instructions which define such operation. The device's program instructions may be stored in a storage device 820 (e.g., magnetic disk, database) and loaded into memory 830 when execution of the console's program instructions is desired. Thus, the device's operation will be defined by the device's program instructions stored in memory 830 and/or storage 820, and the console will be controlled by processor 850 executing the console's program instructions. A device 800 also includes one or a plurality of input network interfaces for communicating with other devices via a network (e.g., the internet). A device 800 also includes one or more output network interfaces 810 for communicating with other devices. Device 800 also includes input/output 840, representing devices which allow for user interaction with a computer (e.g., display, keyboard, mouse, speakers, buttons, etc.). One skilled in the art will recognize that an implementation of an actual device will contain other components as well, and that FIG. 8 is a high level representation of some of the components of such a device for illustrative purposes. It should also be understood by one skilled in the art that the method and devices depicted in FIGS. 1 through 7 may be implemented on a device such as is shown in FIG. 8.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A method of storing searchable still images of a pre-designated portion of a video output, comprising:
designating a portion of said video output as an active window;
storing a still image version of said active window, upon non-printable user input or upon designation of a new portion of said video output to become said active window;
associating with said still image all printable input received from a user between said step of designating and said step of storing; and
displaying said still image version with at least a portion of said printable input.

2. The method of claim 1, wherein said displaying of said still image version is based on a query comprising at least said portion of said printable input in a search query.

3. The method of claim 2, wherein a plurality of still images is stored, and each still image is associated with printable input corresponding to a still image of said plurality of still images.

4. The method of claim 3, wherein said still images are exhibited in sequence, by time.

5. The method of claim 4, wherein said still images are exhibited to a remote video screen in real-time.

6. The method of claim 3, wherein said plurality of images comprises images from a first video screen and a second video screen.

7. The method of claim 2, wherein a title for said active window is associated with said still image version, and a search query comprising at least a part of said title returns a result which comprises said still image version.

8. The method of claim 7, comprising a further step of optical character recognition to generate text from said still image version, wherein said generated text is further searchable by way of said search query.

9. The method of claim 8, wherein said generated text is designated as being part of an actionable object.

10. The method of claim 5, wherein said remote real-time video is triggered based on a pre-defined printable input.

11. The method of claim 1, wherein network access to a computer which outputs said video is limited based on a printable input matching a pre-defined string.

12. A server comprising:
a data storage device configured to store still image versions of an active window of a video output, wherein said still images are associated with printable text characters inputted by a viewer interacting, by way of a hardware input device, with said active window of said video output;
an input interface adapted to receive a text-based search query;
an output interface adapted to send, in response to said text-based search query, results comprising at least a portion of printable text characters inputted using said hardware input device of said viewer and at least one still image associated with said at least a portion of said printable text characters inputted by said viewer.

13. The server of claim 12, wherein said still image versions of said active window are stored upon non-printable input of said viewer or upon designation of a new portion of said video output as said active window.

14. The server of claim 12, wherein said server sends, via said output interface, each still image version of said still image versions in a sequence, sorted by time.

15. The server of claim 14, wherein said still image versions are exhibited to a remote video screen in real-time.

16. The server of claim 13, wherein said still image versions comprise images from a first video screen and a second video screen.

17. The server of claim 12, wherein a title for said active window is associated with said still image versions, and a search query comprising at least a part of said title returns a result which comprises said still image version.

18. The method of claim 17, wherein said text-based search query also comprises a search of text gleaned from said video output of said active window by way of optical character recognition used to generate said text from said still image version of said video output.

19. The method of claim 18, wherein said text gleaned from said video output is designated in said search result as being part of an actionable object.

20. The method of claim 15, wherein said remote real-time video is triggered based on a pre-defined printable input.

21. The method of claim 12, wherein network access to a computer associated with said video output is limited based on when said printable text characters match a pre-defined string.
